(19) United States
(12) Patent Application Publication
(10) Pub. No.: US 2014/0268560 A1
(43) Pub. Date: Sep. 18, 2014

(54) MOTORIZED MOUNT FOR SEATING SYSTEM

(71) Applicant: Purdue Research Foundation, West Lafayette, IN (US)

(72) Inventor: Bradley S. Duerstock, West Lafayette, IN (US)

(73) Assignee: PURDUE RESEARCH FOUNDATION, West Lafayette, IN (US)

(21) Appl. No.: 14/217,235

(22) Filed: Mar. 17, 2014

Related U.S. Application Data
(60) Provisional application No. 61/790,793, filed on Mar. 15, 2013.

(51) Int. Cl. F16M 13/02; B60R 9/00

(52) U.S. Cl. CPC F16M 13/022; B60R 9/00
USPC 361/679.58

(57) ABSTRACT

The present disclosure illustrates a motorized mount with a plurality of degrees of freedom coupled to a seating system.

### RELATED APPLICATIONS

The present applications claims priority to U.S. provisional patent application 61/790,793 filed Mar. 15, 2013, the content of which is incorporated by reference herein in its entirety.

### GOVERNMENT RIGHTS

This invention was made with government support under GM096842 awarded by the National Institutes of Health. The government has certain rights in the invention.

### TECHNICAL FIELD

The invention described herein pertains to a motorized mount for a seating system, and specifically to a mount system with a plurality of degrees of freedom controlled electronically.

### BACKGROUND

Computing devices may be used for a variety of communication, educational, occupational, and entertainment purposes and, as such, have become an important part of daily life. Furthermore, mobile computing devices may enable persons with disabilities, including wheelchair users, to be more independent and productive wherever they go. Persons with disabilities are often limited to using their computing devices only at a specific location (e.g., their home or office), rather than being able to employ these devices wherever they are. For quadriplegics, the ability to readily access their computing devices when and where needed has been problematic. A quadriplegic has little or no movement in their arms to carry or retrieve computing devices from a book bag, pocket, or case.

Wheelchairs typically do not provide a convenient space or location to store a computing device so that it does not impede the motion of the wheelchair or its user. Powered wheelchair users, particularly those with upper extremity disabilities, currently do not have any way to automatically place computing devices on or about their laps for use and then to retract when not needed. Many commercial wheelchair mounts are rigidly affixed to the wheelchair and must be physically repositioned or removed by someone else in order to go underneath tables or to transfer out of the wheelchair. Swinging away a tray or platform of a mount can be difficult for someone with limited hand or arm strength or dexterity. Additionally, even when the tray is in its retracted position, the mount may still cause an impediment to the wheelchair when positioned under tables or through narrow doorways.

### BRIEF DESCRIPTION OF THE DRAWINGS

The concepts described in the present disclosure are illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. The detailed description particularly refers to the accompanying figures in which:

FIG. 1 illustrates one embodiment of a motorized mount, in a retracted position, coupled to a wheelchair;

FIG. 2 illustrates the motorized mount of FIG. 1 in a first intermediate position, between the retracted position and a first deployed position;

FIG. 3 illustrates the motorized mount of FIG. 1 in a second intermediate position between the retracted position and the first deployed position;

FIG. 4 illustrates the motorized mount of FIG. 1 in a third intermediate position between the retracted position and the first deployed position;

FIG. 5 illustrates the motorized mount of FIG. 1 in the first deployed position;

FIG. 6 illustrates positioning of the motorized mount of FIG. 1 in a second deployed position;

FIG. 7 is a partially exploded perspective view of several components of the mounting assembly and further depicts the motorized mount of FIG. 3;

FIG. 8 further depicts the mounting assembly of FIG. 3, showing an exploded cross-sectional view of several components;

FIG. 9 is a schematic electrical diagram of a control system of the motorized mount of FIG. 1.

FIG. 10 illustrates a front view of the motorized mount of FIG. 1 in the deployed position showing motor assemblies, an attachment assembly to a seating system, an articulating arm assembly, and an attachment member for coupling the mounting assembly;

FIG. 11 illustrates a bottom view of a deployed motorized mount showing the motor assemblies, an attachment assembly, an articulating arm assembly, and the sheet for coupling the mounting assembly;

FIG. 12 illustrates a back view of the motorized mount of FIG. 1, in the first deployed position, providing another view of the motor assemblies, the attachment assembly, the articulating arm assembly, and hinges;

FIG. 13 illustrates a partial view of the motorized mount of FIG. 1, in the first deployed position showing the motor assemblies and locations of limiting switches, the articulating arm assembly, the attachment assembly, the hinges, and the attachment member to couple the mounting assembly;

FIG. 14 illustrates the articulating arm assembly, of the motorized mount of FIG. 1, showing three portions of the articulating arm assembly in a side exploded view;

FIG. 15 illustrates the articulating arm assembly of the motorized mount of FIG. 1 coupled to the hinge and the motor assembly for a motor , as well as, position of the motor between two portions of the articulating arm assembly;

FIG. 16 illustrates a side view of the motorized mount of FIG. 1 in the first deployed position showing coupling arrangement of the attachment assembly, the articulating arm assembly, the motor assemblies, to the attachment member, and locations for hinges;

FIG. 17 illustrates a side view of the motorized mount of FIG. 1 in the first deployed position, showing locations for the limiting switches, the attachment assembly, the motor assemblies, the articulating arm assembly, and the attachment member for coupling the mounting assembly;

FIG. 18. illustrates a partial view of the motorized mount of FIG. 1, showing the attachment assembly, the motor assemblies, the articulating arm assembly, and the attachment member; and

FIG. 19 illustrates the motorized mount of FIG. 1 coupled to a wheelchair and shown in the retracted position.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the present disclosure.

The present disclosure relates generally to a motorized mount for a wheelchair, which may be used to automatically deploy and retract a computing device (e.g., a tablet, a laptop, or other mobile computing device) coupled to an articulating arm. The motorized mount has been designed to attach to a manual or powered wheelchair and to achieve one or more of the following goals: (1) not excessively exceeding the width of the wheelchair to allow passage through standard doorways, (2) being easily attachable to and removable from the wheelchair with simple (or no) tools, (3) not impeding a wheelchair user from transferring into or out of the wheelchair, (4) being operable with a single switch, and (5) not interfering with the standard seat movements or functions of advanced powered wheelchairs with tilting, reclining, standing, and elevating seat functions. It will be appreciated that, in some embodiments, the motorized mount may achieve some, but not all, of the foregoing goals. Furthermore, although the motorized mount is described herein as being coupled (or attachable) to a wheelchair, it is contemplated that the motorized mount may also be used with other seating systems, including recliners, sofas, car seats, passenger seats on public transportation, and beds.

The motorized mount 10 is designed and built to operate according to a plurality of degrees of freedom. Specifically illustrated in FIG. 1-19 are five separate degrees of freedom, allowing the motorized mount to deploy and adjust for the user, and retract to a position which does not hinder any other function of the seating system.

A motorized mount 10 can be coupled to a seating system. FIG. 1 and FIG. 19 illustrate a motorized mount 10 coupled to a wheelchair 12. The motorized mount 10 includes an articulating arm assembly 14, a first motor assembly 100 and a second motor assembly 102, an attachment assembly 106, a mounting assembly 108, and an electrical assembly 110.

The articulating arm assembly 14 illustrated in at least FIG. 14, FIG. 15, and FIG.18 includes three portions. The first portion 14A includes three portions: a middle portion 14A-1, a proximal end 14A-2, and a distal end 14A-3. The second portion 14B includes three portions: a middle portion 14B-1, a proximal end 14B-2, and a distal end 14B-3. The third portion 14C includes three portions: a middle portion 14C-1, a proximal end 14C-2, and a distal end 14C-3. The proximal end 14A-2 and part of the middle portion 14A-1 are coupled to a bracket 40 with one or more fasteners (not shown). The proximal end 14B-2 of the second portion 14B is coupled to the proximal end of 14 C-2 of the third portion 14C by a hinge 30. The distal end of 14C-3 and at least part of the middle portion 14C-1 are coupled to an attachment member 48 by a friction hinge 46.

FIGS. 10, 11, 12, 16, and 17 illustrate an embodiment where the first motor assembly 100 includes a first motor 24 and the second motor assembly 102 includes a second motor 28. Further, the first motor assembly 100 includes first motor 24 coupled to a gearbox 25 which is coupled to a first rotational member 38. The second motor assembly 102 includes a second motor 28 coupled to a gearbox 29 which is coupled to a second rotational member 31. Motor assemblies 100 and 102 are coupled to the electrical assembly 110. The electrical assembly 110 includes limit switches 34, 36, 44, and 46 (further explained below) as illustrated in FIGS. 9, 13 and 17. The motor assemblies 100 and 102 are coupled to a power source (not shown) and an input switch 20. It is well understood to a person having ordinary skill in the art how to outfit the motorized mount 10 with more than two motor assemblies.

An attachment assembly 106 is used to couple the motorized mount 10 to a seating system e.g., a wheelchair. The attachment assembly 106 includes a mounting bracket 32 to couple the motorized mount to the seating system. At least FIGS. 1, 10, 11, 13, and 17 illustrate the mounting bracket 32 which is a right-angled bracket with a side 32A and a horizontal side 32B. The horizontal side 32B is coupled to the distal end 14A-3 and at least a part of the middle portion 14A-1 by a first rotational member 38 of the first motor assembly 100 as shown in FIGS. 1 and 18.

A mounting assembly 108 is used to couple a computer device 16 to the motorized mount 10. A non-limiting example of a mounting assembly is illustrated in FIGS. 1, 6, 7, and 8. The mounting assembly 108 includes an attachment member 48 with a mounting platform 48A and mounting edge 48B. The mounting edge 48B is coupled to the distal end 14C-3 and a part of the middle portion 14C-1 of the third portion 14C of the articulating arm assembly 14. One example of a mechanism to couple mounting edge 48B to distal end of 14C-3 is the friction hinge 46. The mounting platform 48A is coupled to a rotational type bearing 50. An inner portion 52 of the bearing 50 is coupled to a stopping bracket 54 (see FIG. 7). The stopping bracket 54 may include two recesses 56A and 56B formed therein to interact with two screws 58A and 58B that protrude from an outer portion 60 of the bearing 50. The computing device 16 may be coupled to the outer portion 60 of the bearing 50. A platform 62 may be secured to the outer portion 60 of the bearing 50. The computing device 16 may then be removably coupled to the platform 62.

An electrical assembly 110 comprises relays and limit switches coupled to the motor assemblies 100 and 102. FIG. 9 illustrates an example of a circuit diagram. A person having ordinary skill in the art will recognize that the circuit diagram may change depending on the various embodiments of the motorized mount and the coupled seating system. In one embodiment an input switch 20 is coupled to the first motor assembly 100 and limit switches 34 and 36, and second motor assembly 102 and limit switches 42 and 44 by relays. FIG. 9 illustrates relays 70, 72, 74, 76 that allow the first and second motors, 24 and 28, to run in both forward and reverse directions.

Focusing specifically now on one preferred embodiment, FIGS. 1-19 illustrate how the attachment assembly 106, mounting assembly 108, the first motor assembly 100 and the second motor assembly 102, the articulating arm assembly 14, and the electrical assembly 110 are coupled together and to a seating system. FIGS. 1 and 19 illustrate the motorized mount 10 coupled to the wheelchair 12 by the attachment assembly 106.

An input switch 20 may be mounted on an armrest 18. Depending on the input switch it may be mounted in different locations on the seating system to be accessible to a user. The input switch 20 is coupled to the motor assemblies 100 and 102 by the electrical assembly 110. FIG. 9 provides a circuit diagram illustrating the electrical assembly 110 coupling the motor assemblies 100 and 102 to the input switch 20.

FIGS. 16, 17, and 18 illustrate the motor assemblies 100 and 102 coupled to the articulating arm assembly 14, mounting assembly 108, and attachment assembly 106. The first motor assembly 100 including motor 24, gearbox 25, and the first rotational member 38, are coupled to the mounting bracket 32. The limit switches 34 and 36 are positioned near gearbox 25. The distal end 14A-3 and at least a portion of the middle portion 14A-1 of articulating arm 14A is coupled to the shaft of motor 24 by first rotational member 38. The proximal end 14A-2 and a portion of the middle portion 14A-1 are coupled to the bracket 40. The second motor assembly 102 including the second motor 28, gearbox 29, and second rotational member 31 are coupled to bracket 40 as shown in FIG. 18. The limit switches 42, 44 are positioned near gearbox 29. The middle portion 14B-1 of second portion 14B of articulating arm assembly 14 is coupled to the bracket 40 by the second rotational member 31. The proximal end 14B-2 is coupled to the hinge 30.

The third portion 14C of the articulating arm assembly 14 may include a single piece or multiple pieces of metal coupled by a plurality hinges providing a plurality of degrees of freedom as illustrated in FIGS. 3, 5, 6, 14, and 15. In one illustrative embodiment the third portion 14C includes a single piece of metal coupled to a friction hinge 46. The friction hinge 46 couples distal end 14C-3 and part of the middle portion 14C-1 of the third portion 14C to the mounting edge 48B of the attachment member 48. The friction hinge 46 may couple the third portion 14C and mounting edge 48B in several orientations and is not limited to a single placement (e.g., the friction hinge may connect underneath the third portion 14C and attachment member 48, from the bottom of both of third portion 14C and mounting edge 48B, or on the top of third portion 14C and the bottom of mounting edge 48B).

The movements of the motorized mount 10 may be partially or entirely controlled by the motor assemblies 100 and 102. The movements are based on distinct degrees of freedom. The first degree of freedom is illustrated by the movement of the articulating arm assembly 14 moving first portion 14A coupled to the first motor assembly 100, in a first degree of freedom of up to 180 degrees. This first movement may move the mounting assembly from near the back tire of a wheelchair 12, for example, to the near the front tire in a deploying manner. In the first degree of freedom, the mounting assembly 108 moves horizontally in the ‘x’ direction about the y-axis , 22, as illustrated in FIG. 2. Alternatively, the first portion 14A may move the coupled mounting assembly 108 from near the front tire of a wheelchair 12, as an example, to near the back tire in a retracting manner. The second degree of freedom is illustrated when second portion 14B moves vertically up to 180 degrees from near the front tire of wheelchair 12, to near the arm rest 18. In the second degree of freedom, the mounting assembly 108 moves vertically in the ‘y’ direction about the x-axis, 26, as illustrated by FIG. 4. The third degree of freedom is illustrated in FIG. 5. The third portion 14C moves down vertically in a 90 degree rotation in the ‘y’ direction. This results in the mounting assembly 108 stopping parallel to the seat of wheelchair 12. In one example, this movement is achieved by hinge 30. The fourth degree of freedom is achieved by the friction hinge 46. Friction hinge 46 is coupled to mounting edge 48B of the attachment member 48 and distal end 14C-3 and a portion of the middle portion 14C-1 to control the movement and position of the attachment member 48. The fifth degree of freedom is produced by the mounting assembly 108 and is illustrated in FIGS. 6 and 7. The rotational type bearing 50 provides the ability to rotate the attached computer device 16 at least 90 degrees from its starting position. The stopping bracket 54 and screws 58A and 58B provide the braking mechanism to stop the rotation of the computer device 16.

Referring now to FIGS. 1-6, one illustrative embodiment of a motorized mount 10 is shown coupled to a power wheelchair 12. The motorized mount 10 is illustrated as coupled to a right side of the wheelchair 12, the motorized mount 10 may be mounted on a left side of the wheelchair 12 in other embodiments. As described further below, the motorized mount 10 includes an articulating arm assembly 14 that can move in two or more degrees of freedom. A computing device 16 may be coupled at or near one end of the articulating arm assembly 14. Collectively, FIGS. 1-6 illustrate a movement of the articulating arm assembly 14 from a retracted position (FIG. 1) to a deployed position (FIG. 6). As illustrated in the figures, this movement of the articulating arm assembly 14 is operable to move the computing device 16 from a retracted position (FIG. 1) to a deployed position. Beginning in FIG. 1, the articulating arm assembly 14 and the computing device 16 are in the retracted position. In this position, both the articulating arm 14 and the computing device 16 do not substantially exceed a width of the wheelchair 12, allowing the wheelchair 12 to travel through doorways and other narrow passages. Further, when in the retracted position, both the articulating arm assembly 14 and the computing device 16 are positioned below an arm rest 18 of the wheelchair 12, allowing the wheelchair 12 to travel under tables, desks, and the like.

In the illustrative embodiment, when a user activates an input switch 20 that is mounted on the arm rest 18, the articulating arm assembly 14 will rotate using the first motor assembly 100 including the first rotational member 38 about an axis 22, as shown in FIG. 2. As illustrated in FIG. 1, pushing the input switch 20 forward may cause the first portion 14A to extend and move toward the deployed position, while pulling the input switch 20 back may cause the first potion 14A of articulating arm assembly 14 to move toward the retracted position. In the illustrative embodiment, if the input switch 20 is in at its center (default) position, the articulating arm assembly 14 will not move until the switch is moved in either direction. It is contemplated that, in other embodiments, the motorized mount 10 may be controlled by other input methods, such as sip-and-puff, eye gazing, brain-controlled interfaces. In such embodiments, alternative input devices may plug into an optional controller to operate the motorized mount 10. The articulating arm assembly l4 will continue rotating about the axis 22 until it reaches the second intermediate position shown in FIG. 3. As described further below, the rotational movement of the articulating arm assembly l4 shown in FIGS. 1-3 may be controlled by a first motor assembly 100 of the motorized mount 10.

After reaching the second intermediate position shown in FIG. 3, a portion of the articulating arm assembly 14, second portion 14B, will rotate about an axis 26, as shown in FIG. 4. The second portion 14B will continue rotating about the axis 26 until it reaches the third intermediate position shown in FIG. 4. As described further below, the rotational movement of the second portion 14B shown in FIG. 4 may be controlled by second motor assembly 102 of the motorized mount 10. As shown in FIG. 5, the articulating arm assembly 14 may also include a hinge 30 that allows manual movement of the computing device 16 from the third intermediate position shown in FIG. 4 to the first deployed position in the wheelchair 12 user's lap. Once in the first deployed position, the third portion 14C may allow for further manual positioning of the computing device 16, such as tilting and rotating, as shown in FIG. 6. In other embodiments, the movements of the third portion 14C shown in FIGS. 5,6, 18 may be motorized (rather than manually controlled).

The motorized mount 10 may be coupled to the wheelchair 12 by the attachment assembly 106 using any number of mechanisms. In the illustrative embodiment, a mounting bracket 32 of the attachment assembly 106 is coupled to a seating system of the wheelchair 12. One example includes a number of bolts placed through a number of holes formed in the mounting bracket 32 to secure it to the wheelchair 12. The mounting assembly 106 (as well as any other components of the motorized mount 10) may comprise any durable substance, such as aluminum, titanium, iron, steel, resin, or the like. In some illustrative embodiments, the mounting bracket 32 may have a length of 1 to 7 inches, a diameter of 0.25 to 3 inches, a depth of 0.25 to 3 inches. It will be appreciated that the attachment of the motorized mount 10 will vary according to the style of wheelchair 12 and/or the seating system used. Those skilled in the art will recognize that adjustments may be made to the motorized mount 10, including the mounting bracket 32, to fit different brands and models of wheelchairs 12 (as well as other seating systems).

The first motor 24, as well as limit switches 34, 36 are coupled to the mounting bracket 32. The limit switch 34 is mounted to the forward side of the mounting bracket 32, as shown in FIGS. 1 and 2. For instance, a right angle piece of aluminum may be coupled to the mounting bracket 32 and used to mount the limit switch 34 such that its button points toward the right side of the wheelchair 12 (from the perspective of the user shown in FIGS. 1-6). The limit switch 36 is mounted in the same manner but on rear side of the mounting bracket 32, as shown in FIGS. 2-6, and FIG. 17.

The first motor 24 is illustratively embodied as a cylindrical member with a depth of about two inches and a diameter of about 1.4 inches. The first motor 24 may be powered by any electrical power source (e.g., of 10 to 24 V DC). In the illustrative embodiment, the first motor 24 is coupled to a steal gear box 25 with the length-width-height dimensions of 3×2.8×0.8 inches. The first motor 24 may be mounted such that a shaft of the motor 24 is oriented generally perpendicular to the surface on which the wheelchair 12 sits (e.g., the ground). The first portion 14A of articulating arm assembly 14 is coupled to the shaft of the first motor 24 via a first rotational member 38, which may be made of plastic, metal, metal alloy, and the like.

As shown in FIGS. 1-3, the first motor 24 may be operable to swing the first rotational member 38, articulating arm assembly 14, second motor assembly 102, attachment member 48, and mounting assembly 108 about the axis 22 over the 180 degrees bounded by the limit switches 34, 36. In other embodiments, the first motor 24 might be operable to cause translation of the articulating arm assembly 14 relative to the wheelchair 12 (rather than rotation). For stability and strength, the first portion 14A may illustratively be formed of a hollow 1×1 inch square prism of 0.15 inch thick aluminum. In other embodiments, other materials and/or structures may be used to form the first portion 14A. The second motor 28 is coupled to bracket 40. In the illustrative embodiment, the first portion 14A of the articulating arm assembly 14 between the motors 24, 28 may be about 11.5 inches in length. In the illustrative embodiment, the second motor 28 is coupled to the second portion 14B of the articulating arm assembly 14 by a right angle bracket 40 formed of 0.15 inch thick aluminum and having length-width-height dimensions of 4.7×1×1 inches.

The second motor 28 is illustratively embodied as an aluminum cylindrical motor with a depth of about 1.4 inches and a diameter of about 1 inch Like the first motor 24, the second motor 28 may be powered by any electrical power source (e.g., of 10 to 24 V DC). In the illustrative embodiment, the second motor 28 is coupled to a steal gear box 29 with the length-width-height dimensions of 3×2.8×0.8 inches and a second rotational member 31. Limit switch 42, 44 are also mounted to the bracket 40 supporting the second motor 28. As shown in FIGS. 1-3, 6 and 17, the limit switches 42, 44 are positioned near a gearbox 29 of the motor 28 such that a button of each of the limit switches 42, 44 faces towards the wheelchair 12 (when the motorized mount 10 is in the retracted position) or away from the wheelchair 12 (when the motorized mount 10 is in the deployed position). As described further below, the limit switch 42 is activated (by the articulating arm 14) during deployment of the motorized mount 10, while the limit switch 44 is activated (by the articulating arm 14) during retraction of the motorized mount 10.

For mobility and functionality, second portion 14B and third portion 14C are coupled by hinge 30. In the illustrative embodiment, second portion 14B is coupled to second motor 28 by the second rotational member 31 and will not rotate more than 180 degrees about the axis 26 (FIG. 4) due to the limit switches 42, 44. In the illustrative embodiment, second portion 14B is formed of 0.15 inch thick aluminum and has length-width-height dimensions of 4.7×1×1 inches. Second portion 14B ensures the limit switches 42, 44 are pressed when the upper and lower limits have been reached. The proximal end 14B-2 of the the second portion 14B is coupled to the proximal end of 14 C-2 of the third portion 14C by by a hinge 30 to allow the computing device 16 of mounting assembly 108 to be rotated 90 degrees from the third intermediate position shown in FIG. 4 to the first deployed position shown in FIG. 5. In the illustrative embodiment, second portion 14B is formed of 0.15 inch thick aluminum and has length-width-height dimensions of 2.4×1.75×1 inches. As best seen in FIG. 6, third portion 14C supports a friction hinge 46 that allows a user to tilt the computing device 16 upward to improve a viewing angle. In the illustrative embodiment, third portion 14C is formed of 0.15 inch thick aluminum and has length-width-height dimensions of 4.5×1×1 inches. The friction hinge 46 may have a range of 180 degrees and may use a screw to set the friction/ease of mobility for the hinge 46. The friction hinge 46 may be coupled to and attachment member 48 of plastic, metal, metal alloy, or the like, such as that shown in FIGS. 7 and 8. In one illustrative embodiment, the attachment memeber 48 is comprised of Plexiglass.

In the illustrative embodiment, the mounting assembly 108 includes attachment member 48 coupled to a rotational type bearing 50 that allows the computing device 16 to be rotated 90 degrees. As best seen in FIG. 7, an inner portion 52 of the bearing 50 is coupled to a stopping bracket 54. In the illustrative embodiment, the stopping bracket 54 is 5×0.7 inch piece of aluminum. The stopping bracket 54 includes two recesses 56A and 56B formed therein to interact with two screws 58A and 58B that protrude from an outer portion 60 of the bearing 50.

The screws 58A and 58B are orientated about 90 degrees apart and provide stops of the stopping bracket 54 and the bearing 50.

The computing device 16 may be coupled to the outer portion 60 of the bearing 50 in a number of ways (which helps to accommodate a variety of different types of computing devices 16). In some embodiment, a platform 62 of plastic, metal, metal alloy, or the like may be secured (via a number of fasteners) to the outer circle 60 of the bearing 50. The computing device 16 may then be removably coupled to the platform 62 via VELCRO, magnets, suction, snaps, adhesive, or other suitable mechanisms. In other embodiments, a case of the computing device 16 may be directly coupled to the outer circle 60 of the bearing 50. In still other embodiments, specific adaptors could be developed to mount various computing devices 16 to the outer portion 60 of the bearing 50. FIGS. 7 and 8 illustrate a partially exploded perspective view and an exploded cross-sectional view, respectively, of the bearing 50 and its neighboring components. In some embodiments, the platform 62 may be used for multiple purposes besides holding a computing device 16, such as holding alternative and augmentative communication (AAC) devices, environmental control units, a camera mount, a writing desk, a cup holder, an umbrella holder, etc.

Referring now to FIG. 9, a schematic diagram of the illustrative embodiment of the motorized mount 10 is shown. The input switch 20, the first and second motors 24, 28, and the limit switches 34, 36, 42, 44 discussed above are all illustrated in FIG. 9. The motorized mount 10 also includes relays 70, 72, 74, 76 that allow the first and second motors 24, 28 to run in both forward and reverse directions. The input switch 20 is illustratively embodied as a momentary single pole double throw (SPDT) input switch 20 that controls whether the motorized mount 10 moves toward the retracted position, moves toward the deployed position, or remains neutral. In other embodiments, the user might instead utilize a sip and puff, a brain-controlled interface, voice recognition, gesture recognition, a touch screen interface, and/or other commercial switches to control operation of the motorized mount 10. In any case, the user's input will control the articulating arm assembly 14 via the relays 70, 72, 74, 76 and the limit switches 34, 36, 42, 44.

When the articulating arm assembly 14 is moving toward the deployed position (as illustrated across FIGS. 1-6) by first portion 14A, the input switch 20 connects a diode 78 to the supply voltage (which may be 10 V to 24 V, as noted above). This activates relay 70, causing the first motor 24 to run until the limit switch 34 is reached. When the limit switch 34 flips, the first motor 24 breaks and relay 72 activates. When activated, relay 72 powers the second motor 28 until the limit switch 42 is reached. When the articulating arm assembly 14 is moving toward the retracted position, the input switch 20 connects a diode 80 to the supply voltage. This activates relay 74, causing the second motor 28 to run in the opposite direction from above, until the limit switch 44 is reached. When the limit switch 44 flips, the second motor 28 breaks and relay 76 activates. When activated, relay 76 powers the first motor 24 in the opposite direction, until the limit switch 36 is reached.

While one illustrative embodiment of the motorized mount 10 for a wheelchair 12 has been described above with reference to FIGS. 1-19, it is contemplated that other embodiments of the motorized mount 10 may have additional or different features. For instance, while several portions of the articulating arm assembly 14 are described above as having manual hinges or bearings, it would also be possible to add additional motors to move the portions automatically. This would likely add more weight to the motorized mount 10, but may be desirable for individuals who cannot manually move portions of the articulating arm assembly 14. The mechanics of the motorized mount 10 (e.g., the motors) might also be made more rugged by using higher gear ratio motors and stronger materials. This upgrade may be desirable for carrying larger computing devices 16 (e.g. laptop computers) and other equipment heavier than approximately five pounds. Where an alternative input device (e.g. a sip and puff, a touch switch, a magnetic switch, electromyography, etc.) is used in place of the input switch 20, the motorized mount 10 may include an electronic controller for interpreting signals from the alternative input device. This controller might process other signal related to the wheelchair 12 as well (e.g., a video feed from a camera mounted on the chair). It is contemplated that the motorized mount 10 may be powered by either the batteries of the wheelchair 12 or an external power source, including, but not limited to, separate batteries, solar power, or kinetic power.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of the apparatus, systems, and methods that incorporate one or more of the features of the present invention and fall within the spirit and scope of the present disclosure.

1. A motorized mount comprising;
a mounting bracket configured to attach to a seating system;
an articulating arm configured to attach to the mounting bracket having a first potion and a second portion, and a computer device coupled to one end of the articulating arm ;
a first motor configured to attach to the mounting bracket configured to move the articulating arm based on a first degree of freedom; and
a second motor configured to attach between the first and second portion of the articulating arm configured to move the articulating arm based on a second degree of freedom;

2. The motorized mount of claim 1 further comprising a hinge to move the computer device based on a third degree of freedom.

3. The motorized mount of claim 2 further comprising, a friction hinge configured to move the computer device based on a fourth degree of freedom.

4. The motorized mount of claim 3 further comprising a bearing to move the computer device based on a fifth degree of freedom.

5. The motorized mount of claim 1 further comprising; an input switch configured to control the motor and motor having the ability to move the articulating arm and computer device to a deployed position or a retracted position.

6. The motorized mount of claim 5, wherein the switch is a single throw double pole switch, a sip and puff switch, a brain-controlled interface, a voice recognition switch, a gesture recognition switch, or a touch screen interface.

7. The motorized mount of claim 1, wherein the mounting bracket is configured to attach to a wheelchair, furniture, or hospital bed.

8. The motorized mount of claim 1, wherein the computer device is a tablet, camera, laptop, and alternative and augmentative communication devices.

9. The motorized mount of claim 1, wherein the first degree of freedom is in a range from 0 to 180 degrees.

10. The motorized mount of claim 1, wherein the second degree of freedom is in a range of 0 to 180 degrees.

11. A motorized mount comprising; a mounting bracket configured to attach to a seating system;
an articulating arm configured to attach to the mounting bracket having a proximal end and a distal end, and a computer device coupled to one end of the articulating arm;
a first motor configured to attach to the mounting bracket configured to move the articulating arm based on a first degree of freedom;
a second motor configured to attach between the proximal end and the distal end of the articulating arm configured to move the articulating arm based on a second degree of freedom; and
a hinge configured to attach to the distal end of the articulating arm to thereby move the computer device based on a third degree of freedom;

12. The motorized mount of claim 11 further comprising, a friction hinge configured to move the computer device based on a fourth degree of freedom.

13. The motorized mount of claim 12 further comprising a bearing to move the computer device based on a fifth degree of freedom.

14. A motorized mount of claim 11, wherein every element is controlled electronically.
